(19) United States
(12) Patent Application Publication
(10) Pub. No.: US 2019/0208174 A1
(43) Pub. Date: Jul. 4, 2019

(54) VIRTUAL REALITY-BASED VIEWING METHOD, DEVICE, AND SYSTEM

(71) Applicant: SHENZHEN SKYWORTH-RGB ELECTRONIC CO., LTD., , Guangdong (CN)

(72) Inventors: Fan YANG, Guangdong (CN); Huazhu SUN, Guangdong (CN); Xiyuan CUI, Guangdong (CN)

(73) Assignee: SHENZHEN SKYWORTH-RGB ELECTRONIC CO., LTD., Guangdong (CN)

(21) Appl. No.: 16/323,676

(22) PCT Filed: Mar. 24, 2017
(86) PCT No.: PCT/CN2017/077987

§ 371 Date: Feb. 6, 2019

(30) Foreign Application Priority Data
Dec. 9, 2016 (CN) 201611130324.2

(51) Int. Cl. H04N 13/117; H04N 5/232; H04N 13/371; H04N 13/378

(52) U.S. Cl. CPC H04N 13/117; H04N 13/378; H04N 13/371; H04N 5/23238

(57) ABSTRACT

Provided are a displaying method, apparatus and system based on a virtual reality technology. The method includes: obtaining current location information of a user relative to a displaying apparatus, and calculating a current viewing angle of the user according to the current location information, where the current viewing angle includes a horizontal viewing angle and a longitudinal viewing angle; obtaining a video image of a user-specified spot captured by an image capturing apparatus in real time; processing the video image according to the current location information and the current viewing angle; and sending the processed video image to the displaying apparatus for display.

### TECHNICAL FIELD

The present disclosure relates to the field of virtual reality technologies, and for example, relates to a displaying method, apparatus and system based on a virtual reality technology.

### BACKGROUND

Recently, virtual reality (VR) technology has developed rapidly and VR-related products have also rapidly increased. A virtual reality system requires a user to wear a special device on his or her head. Although the virtual reality system may provide a full viewing angle experience to the user, it is complicated and expensive to use, and may have some adverse effects on the health of the user, which has limitations.

### SUMMARY

The present disclosure provides a displaying method, apparatus and system based on a virtual reality technology, which may realize that a user may enjoy scenic spots around the world in real time without leaving his or her home just as the user is at the scenic spots.

This embodiment provides a displaying method based on a virtual reality technology. The method includes: obtaining current location information of a user relative to a displaying apparatus, and calculating a current viewing angle of the user according to the current location information, where the current viewing angle includes a horizontal viewing angle and a longitudinal viewing angle; obtaining a video image of a user-specified spot captured by an image capturing apparatus in real time; processing the video image according to the current location information and the current viewing angle; and sending the processed video image to the displaying apparatus for display.

Alternatively, the image capturing apparatus is a 360 degrees panoramic camera.

Alternatively, the processing the video image according to the current location information and the current viewing angle includes: cropping the video image according to the current location information and the current viewing angle if the current viewing angle is less than an angle-of-view of the image capturing apparatus; and scaling the cropped video image according to a resolution of the displaying apparatus.

Alternatively, after the calculating a current viewing angle of the user according to the current location information, the method further comprising: adjusting a capturing angle of the image capturing apparatus if the video image corresponding to the current viewing angle exceeds a range of the video image captured by the image capturing apparatus.

The obtaining a video image of a user-specified spot captured by an image capturing apparatus in real time includes: obtaining a video image captured by the image capturing apparatus in real time after the capturing angle is adjusted.

Alternatively, the adjusting a capturing angle of the image capturing apparatus if the video image corresponding to the current viewing angle exceeds the range of the video image captured by the image capturing apparatus includes: calculating a variation between the current viewing angle and a previous viewing angle; determining whether the video image corresponding to the current viewing angle exceeds the range of the video image captured by the image capturing apparatus according to the variation; and adjusting the capturing angle of the image capturing apparatus if the video image corresponding to the current viewing angle exceeds the range of the video image captured by the image capturing apparatus.

This embodiment provides a displaying apparatus based on a virtual reality technology. The apparatus includes: a current viewing angle obtaining unit, configured to obtain current location information of a user relative to the displaying apparatus, and calculate a current viewing angle of the user according to the current location information, wherein the current viewing angle comprises a horizontal viewing angle and a longitudinal viewing angle; a video image obtaining unit, configured to obtain a video image of a user-specified spot captured in real time by an image capturing apparatus user-specified spot; a video image processing unit, configured to process the video image according to the current location information and the current viewing angle; and a video image sending unit, configured to send the processed video image to the displaying apparatus for display.

Alternatively, the apparatus further includes: an image capturing apparatus capturing angle adjusting unit, configured to adjust a capturing angle of the image capturing apparatus if the video image corresponding to the current viewing angle exceeds a range of the video image captured by the image capturing apparatus. The video image obtaining unit is configured to obtain a video image captured in real time by the image capturing apparatus after the capturing angle is adjusted.

Alternatively, the video image processing unit is configured to: crop the video image according to the current viewing angle if the current viewing angle is less than an angle-of-view of the image capturing apparatus; and scale the cropped video image according to a resolution of the displaying apparatus.

This embodiment further provides a management server. The management server includes the displaying apparatus based on a virtual reality technology according to any one of the foregoing items.

The current viewing angle obtaining unit is configured to obtain the current location information of the user relative to the displaying apparatus, and calculate the current viewing angle of the user according to the current location information, wherein the current location information is acquired by a local image capturing device disposed on the displaying apparatus and sent to a virtual reality device. The video image obtaining unit is configured to receive video images of the user-specified spot in real time captured by remote image capturing devices, wherein the remote image capturing devices are arranged in a plurality of scenic spots. The video image sending unit is configured to send the processed video images to the displaying apparatus for display through a virtual display device.

This embodiment further provides a virtual reality device. The virtual reality device includes the displaying apparatus based on a virtual reality technology according to any one of the foregoing items.

This embodiment further provides a viewing system based on a virtual reality technology, which includes remote image capturing devices, a virtual reality device, a displaying apparatus and local image capturing devices, and the above management server.

This embodiment further provides a displaying system based on a virtual reality technology. The displaying system includes a management server, remote image capturing devices, a displaying apparatus and local image capturing devices, and the above virtual reality device.

This embodiment further provides a computer-readable storage medium storing computer-executable instructions for executing any one of the above-mentioned real-time displaying methods based on a virtual reality technology.

This embodiment provides a management server, which includes one or more processors, a memory, and one or more programs that are stored in the memory and that when executed by one or more processors, perform any one of the above-mentioned displaying methods based on a virtual reality technology.

This embodiment further provides a virtual reality device, which includes one or more processors, a memory, and one or more programs that are stored in the memory and that when executed by one or more processes, perform any one of the above-mentioned displaying methods based on a virtual reality technology.

Current location information of a user relative to a displaying apparatus is obtained, and a current viewing angle of the user is calculated according to the current location information; a video image of a user-specified spot captured in real time by an image capturing apparatus is processed according to the current location information and the current viewing angle; and the processed video image is sent to the displaying apparatus for display, so that the video image of the scenic spot acquired in real time is processed according to the location information of the user, just as the user is standing in front of a window and enjoys the scenery. The video image displayed by the displaying apparatus changes according to the movement of the user, and the user can enjoy the scenery around the world without leaving his or her home, thereby providing a good user experience and a vivid effect.

### BRIEF DESCRIPTION OF DRAWINGS

FIG. 1 is a flowchart of a displaying method based on a virtual reality technology according to an embodiment.

FIG. 2A is a schematic plan view of a horizontal viewing angle of a user according to an embodiment.

FIG. 2B is a schematic plan view of a longitudinal viewing angle of a user according to an embodiment.

FIG. 3 is a schematic diagram of cropping a video image according to an embodiment.

FIG. 4 is a flowchart of a displaying method based on a virtual reality technology according to an embodiment.

FIG. 5 is a block diagram showing a structure of a displaying apparatus based on a virtual reality technology according to an embodiment.

FIG. 6 is a block diagram showing a structure of a displaying apparatus based on a virtual reality technology according to an embodiment.

FIG. 7 is a block diagram showing a structure of a displaying system based on a virtual reality technology according to an embodiment.

FIG. 8 is a block diagram showing a structure of a displaying system based on a virtual reality technology according to an embodiment.

FIG. 9 is a schematic diagram showing a hardware structure of a management server or virtual reality device according to an embodiment.

### DETAILED DESCRIPTION

To make technical solutions and technical effects of the present disclosure clearer, the technical solutions of the present disclosure will be described below with reference to accompanying drawings. The described embodiments are only a part but not all of the embodiments of the present disclosure. In case of no conflict, the following embodiments and technical features in these embodiments may be combined with each other.

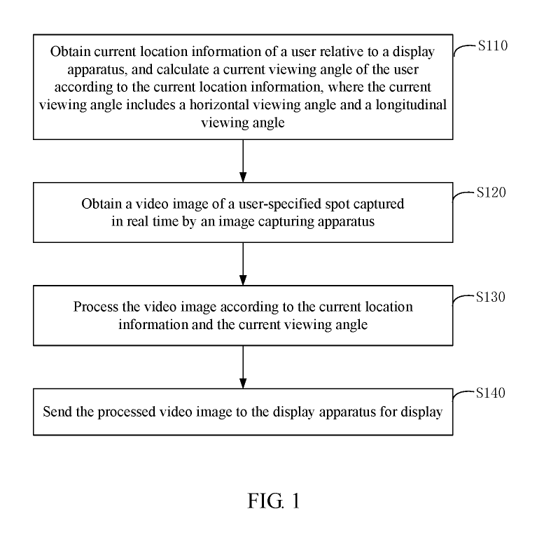

FIG. 1 is a flowchart of a displaying method based on a virtual reality technology according to this embodiment. The method may be performed by a displaying apparatus based on a virtual reality technology configured in a management server or by a displaying apparatus based on a virtual reality technology configured in a virtual reality device. With reference to FIG. 1, the method may include steps S110 to S140.

In S110, current location information of a user relative to a displaying apparatus is obtained, and a current viewing angle of the user is calculated according to the current location information. The current viewing angle includes a horizontal viewing angle and a longitudinal viewing angle.

Alternatively, the current location information of the face of the user relative to the displaying apparatus is obtained in real time, and the current viewing angle of the user is calculated according to the location information relative to the displaying apparatus.

Alternatively, a camera is disposed on the upper end of the displaying apparatus, and the camera may detect whether there is a user in front of the displaying apparatus in real time as well as a change in a location of the user. The current location information of the user is obtained timely by tracking a change in a location of the face of the user by the camera. After the camera is mounted on the displaying apparatus, the location of the camera with respect to the displaying apparatus and a capturing field angle of the camera are all known parameters. An average pupillary distance of users is also a known parameter. Information about an angle of the face of the user with respect to the displaying apparatus may be obtained by processing an image captured by the camera, so that a distance between the user and a display screen may be estimated by the parameters of the camera and the pupillary distance of the user in the image captured by the camera. In addition, the location information of the user may be expressed by establishing a three-dimensional coordinate system. A center location of the displaying apparatus or a lower left corner of the displaying apparatus may be selected as the origin of the three-dimensional coordinate system.

There are many ways to obtain face information of the user. For instance, the displaying apparatus is provided with three image capturing apparatuses, a location of the face of the user in front of the displaying apparatus may be determined through location parameters of the image capturing apparatuses.

In addition, distance measurement of an infrared apparatus and face tracking algorithm of the cameras may be combined to determine the location information of the user.

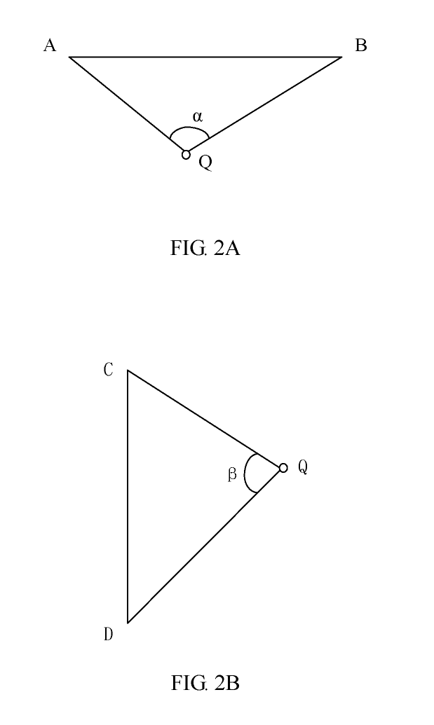

The current viewing angle may include the horizontal viewing angle and the longitudinal viewing angle. FIG. 2A is a schematic plan view of a horizontal viewing angle of a user according to this embodiment. As shown in FIG. 2A, the horizontal viewing angle α is an included angle between two points (a point A and a point B) on the left side and the right side of the displaying apparatus on the same horizontal plane as the location of the face of the user and the location Q of the face of the user (for example, the eyes of the user), Q denotes the location of the face of the user, AB denotes a horizontal length of the displaying apparatus, and the included angle α denotes the horizontal viewing angle. FIG. 2B is a schematic plan view of a longitudinal viewing angle of a user according to this embodiment. As shown in FIG. 2B, the longitudinal viewing angle β is an included angle between two points (a point C and a point D) on the upper side and the lower side of the displaying apparatus on the same longitudinal plane as the location of the face of the user and the location Q of the face of the user (for example, the eyes of the user), Q denotes the location of the face of the user, CD denotes a longitudinal length of the displaying apparatus, and the included angle β denotes the longitudinal viewing angle. In actual calculation, both the horizontal viewing angle and the longitudinal viewing angle may select the middle point between two eyes as the vertex of the included angle, or the left eye or the right eye is selected as the vertex of the included angle, which is determined according to an actual situation.

In S120, a video image of a user-specified spot captured by an image capturing apparatus in real time is obtained.

The user may select a scenic spot he or she wants to enjoy, and get a video image of the scenic spot which is captured in real time by the image capturing apparatus matching with the scenic spot.

Alternatively, the image capturing apparatus may be a camera. The camera may be a 360-degree panoramic camera. Both the horizontal angle-of-view and the longitudinal angle-of-view of the camera are greater than 180 degrees, and the view angle of the user will fall within the range of the angle-of-view of the camera regardless of the movement of the user. In addition, a wide-angle camera may be selected as the image capturing apparatus.

Alternatively, the video image is captured in real time, and a capturing interval can be accurate to microseconds or milliseconds, such that the video image seen by the user is the current real scenery of the scenic spot when the user's location in front of the displaying apparatus changes, and the movement of people and any change in the scenic spot can be displayed in real time on the displaying apparatus.

In S130, the video image is processed according to the current location information and the current viewing angle of the user.

Alternatively, if the current viewing angle of the user is less than the angle-of-view of the image capturing apparatus, the video image is cropped according to the current location information and the current viewing angle; and the cropped video image is scaled according to a resolution of the displaying apparatus.

When the image capturing apparatus is a 360-degree panoramic camera, it is assumed that a horizontal angle-of-view and a longitudinal angle-of-view of the camera are both 180 degrees, the current horizontal viewing angle of the user is 50 degrees, and the longitudinal viewing angle of the user is 30 degrees. Since the video image captured by the image capturing apparatus is larger than an image displayed on the displaying apparatus, it is necessary to crop the video image according to the current viewing angle and the current location information of the user.

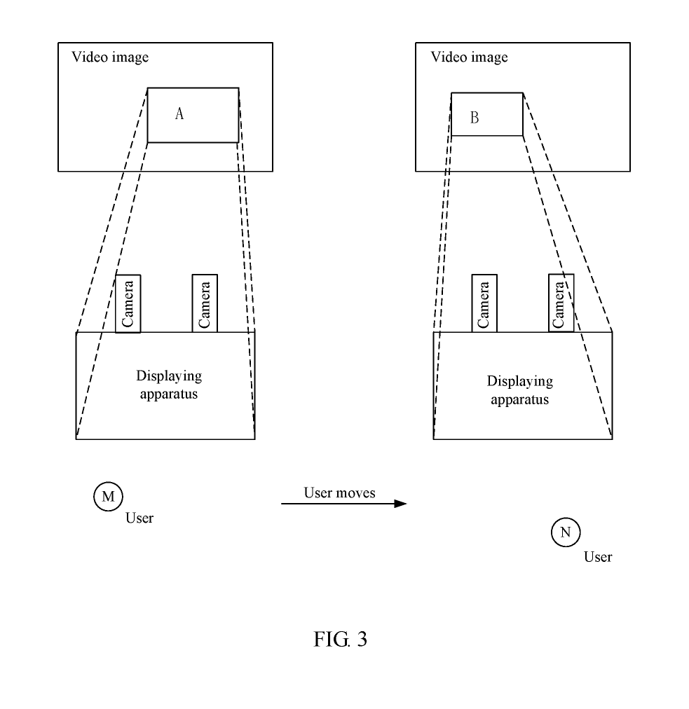

FIG. 3 is a schematic diagram of cropping a video image according to this embodiment. With reference to FIG. 3, when the user moves from a first position M to a second position N in front of the displaying apparatus, the current viewing angle of the user also changes, that is, the viewing angle of the user at the second position N is smaller than the viewing angle of the user at the viewing angle of the user at the first position M.

Therefore, it is also necessary to adjust the video image cropped by a virtual reality device according to the second location N of the user. Before the location of the user changes (that is, the user is at the first position M), the video image displayed by the displaying apparatus is a content of a region A cropped from the video image captured by the remote image capturing apparatus. After the location of the user changes (that is, the user is at the second position N), the video image displayed by the displaying apparatus is a content of a region B cropped from the video image captured by the remote image capturing apparatus. According to the current location information of the user (the user is currently at the second position N), the video image captured by the remote image capturing apparatus is cropped, and the cropped content is scaled and then sent to the displaying apparatus, and the displaying apparatus displays the scaled video image.

At this time, since the video image can change according to the location of the user, the user may enjoy different sceneries from a window as the location of the user changes just as the user stands in front of the window and enjoys the scenery outwards.

For example, the location information of the user relative to the displaying apparatus is expressed by a three-dimensional coordinate system, with a center point of the displaying apparatus (a center point 0 of the displaying apparatus as shown in FIG. 3) as an origin. A two-dimensional coordinate system is established with a center point of the video image captured by the camera as an origin. When a location coordinate of the user is (x, y, z), the coordinate of the center point of the cropped video image is (−x, −y). When the user moves, the center point of the cropped video image also moves correspondingly, and a suitable video image is obtained by cropping according to the current viewing angle. A resolution of the cropped video image is probably not in accordance with the resolution of the displaying apparatus. Therefore, the cropped video image may also be scaled according to the resolution of the displaying apparatus, so that the processed video image is excellently displayed on the displaying apparatus.

When the current location of the user exceeds a preset range, the displaying apparatus may remind and inform the user that viewing may not be performed at the current location or the current location is not beneficial to viewing. For example, the displaying apparatus is provided with a camera, and the camera may acquire the current location information of the user. If the user in not within the angle-of-view of the camera, it may be determined that the user has exceeded the preset range and the displaying apparatus reminds the user by alarm.

Alternatively, two cameras may be disposed on the displaying apparatus to increase a capturing range in order to enlarge an activity area of the user.

In S140, the processed video image is sent to the displaying apparatus for display.

The cropped video image in the S130 is sent to the displaying apparatus for display. Alternatively, the displaying apparatus may be a liquid crystal display screen.

According to the displaying method based on a virtual reality technology in this embodiment, current location information of a user relative to a displaying apparatus is obtained, and a current viewing angle of the user is calculated according to the current location information; and a video image of a user-specified spot captured in real time by an image capturing apparatus is processed according to the current location information and the current viewing angle; and the processed video image is sent to the displaying apparatus for display, so that video images of a scenic spot which are captured in real time are processed according to the location information of the user, just as the user is standing in front of a window and enjoying the scenery, thereby meeting a user's demand of enjoying the scenery around the world without leaving his or her home, with good user experience and vivid effect.

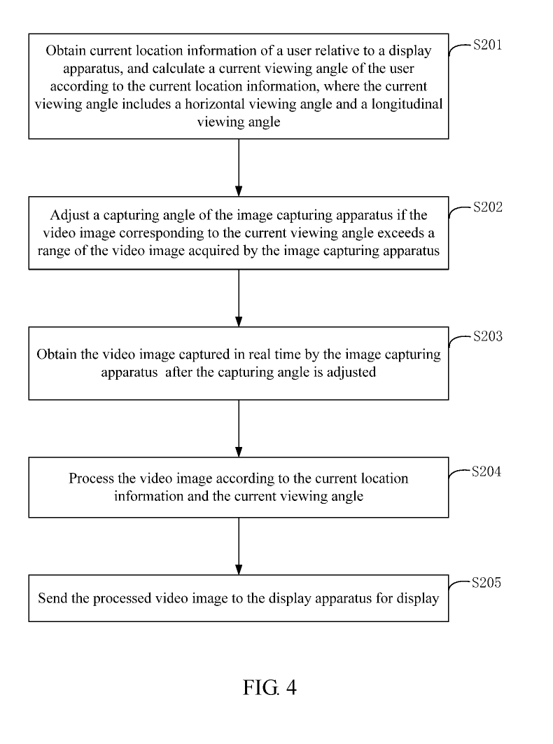

FIG. 4 is a flowchart of a displaying method based on a virtual reality technology according to this embodiment. This embodiment is based on the above-mentioned method, and provides a specific implementation for a case where the video images captured by the image capturing apparatus with the angle-of-view cannot meet the demand. With reference to FIG. 4, the method may include steps S201 to S205.

In S201, current location information of a user relative to a displaying apparatus is obtained, and a current viewing angle of the user is calculated according to the current location information.

Alternatively, the current viewing angle of the user includes a horizontal viewing angle and a longitudinal viewing angle.

In S202, if the video image corresponding to the current viewing angle exceeds the video image captured by the image capturing apparatus, a capturing angle of the image capturing apparatus is adjusted.

When a lens of a camera is fixed, the camera has a fixed angle-of-view. For instance, a general outdoor camera has an angle-of-view of 150 degrees. When the base of the camera is fixed, in order to enlarge a capturing range of the camera, the lens of the camera is configured to be rotatable and the capturing range may be enlarged by rotating the lens of the camera.

Alternatively, a variation between the current viewing angle and the previous viewing angle may be calculated, and whether the video image corresponding to the current viewing angle exceeds the range of the video image captured by the image capturing apparatus or not is determined according to the variation of the viewing angle of the user.

For example, for a video image captured by the camera with the angle-of-view of 150 degrees, if the video image cropped based on the previous location information of the user is already at the edge of the video image captured by the camera, when the user moves again, it can be determined that the video image to be cropped in the next time will exceed the range of the video image captured by the camera.

If the video image corresponding to the current viewing angle exceeds the range of the video image captured by the image capturing apparatus, the capturing angle of the image capturing apparatus is adjusted.

If it is determined that the video image to be cropped in the next time has exceeded the range of the video image captured by the camera, a lens angle of the camera is adjusted and the video image satisfying a cropping demand is captured.

In S203, a video image captured by the image capturing apparatus in real time after the capturing angle is adjusted is obtained.

In S204, the video image is processed according to the current location information and the current viewing angle.

In S205, the processed video image is sent to the displaying apparatus for display.

For the related operations in S201 to S205, reference may be made to FIG. 1 and the content in the embodiment corresponding to FIG. 1.

According to the displaying method based on a virtual reality technology in this embodiment, the current location information of a user relative to a displaying apparatus is obtained, and a current viewing angle of the user is calculated according to the current location information; if the video image corresponding to the current viewing angle exceeds a range of the video image captured by the image capturing apparatus, the capturing angle of the image capturing apparatus is adjusted; the video image captured by the image capturing apparatus in real time after the capturing angle is adjusted is obtained, the video image is processed according to the current location information and the current viewing angle; and the processed video image is sent to a displaying apparatus for display, so that a video image, which is acquired in real time, of a scenic spot is processed according to the location information of the user, just as the user is standing in front of a window and enjoys the scenery. If the video image captured by the image capturing apparatus does not meet a cropping requirement, the capturing angle of the remote image capturing apparatus is adjusted to enlarge a capturing range, meeting the user's need of enjoying the scenery around the world at home, the user experience is good and the effect is vivid.

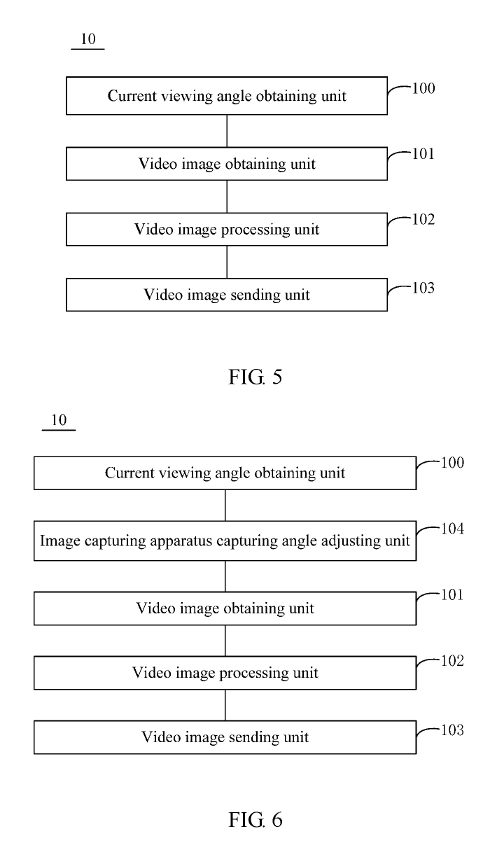

FIG. 5 is a block diagram showing a structure of a displaying apparatus based on a virtual reality technology according to this embodiment. The displaying apparatus based on a virtual reality technology may be configured on a management server or on a virtual reality device. With reference to FIG. 5, the apparatus 10 may include a current viewing angle obtaining unit 100, a video image obtaining unit 101, a video image processing unit 102, and a video image sending unit 103.

The current viewing angle obtaining unit 100 is configured to obtain current location information of a user relative to a displaying apparatus, and calculate a current viewing angle of the user according to the current location information. The current viewing angle includes a horizontal viewing angle and a longitudinal viewing angle.

The video image obtaining unit 101 is configured to obtain a video image of a user-specified spot captured in real time by an image capturing apparatus.

The video image processing unit 102 is configured to process the video image according to the current location information and the current viewing angle. The video image processing unit 102 is particularly configured to: crop the video image according to the current viewing angle if the current viewing angle is less than an angle-of-view of the image capturing apparatus, and scale the cropped video image according to a resolution of the displaying apparatus.

The video image sending unit 103 is configured to send the processed video image to the displaying apparatus for display.

For details of the apparatus, reference may be made to the related description in the method shown in FIG. 1.

According to the displaying apparatus based on a virtual reality technology in this embodiment, the current location information of a user relative to a displaying apparatus is obtained, and a current viewing angle of the user is calculated according to the current location information; and a video image of a user-specified spot captured in real time by an image capturing apparatus is processed according to the current location information and the current viewing angle; and the processed video image is sent to the displaying apparatus for display, so that a video image, which is captured in real time, of a scenic spot is processed according to the location information of the user, just as the user is standing in front of a window and enjoys the scenery, thereby meeting a user's demand of enjoying the scenery around the world at home, with good user experience and vivid effect.

FIG. 6 is a block diagram showing a structure of a displaying apparatus based on a virtual reality technology according to this embodiment. On the basis of the above-mentioned apparatus, this apparatus can realize the adjustment of a capturing angle of an image capturing apparatus. With reference to FIG. 6, the apparatus further includes an image capturing apparatus capturing angle adjusting unit 104.

The image capturing apparatus capturing angle adjusting unit 104 is configured to adjust the capturing angle of the image capturing apparatus if the video image corresponding to the current viewing angle exceeds a range of the video image captured by the image capturing apparatus.

The video image obtaining unit 101 is configured to obtain a video image captured in real time by the image capturing apparatus after the capturing angle is adjusted.

When the range of the video image captured by the image capturing apparatus does not meet a requirement of a movement range of the user, the displaying apparatus based on a virtual reality technology realizes the adjustment of the capturing angle of the image capturing apparatus, enlarges a displaying range, further improves a viewing effect of the user, and has a good user experience.

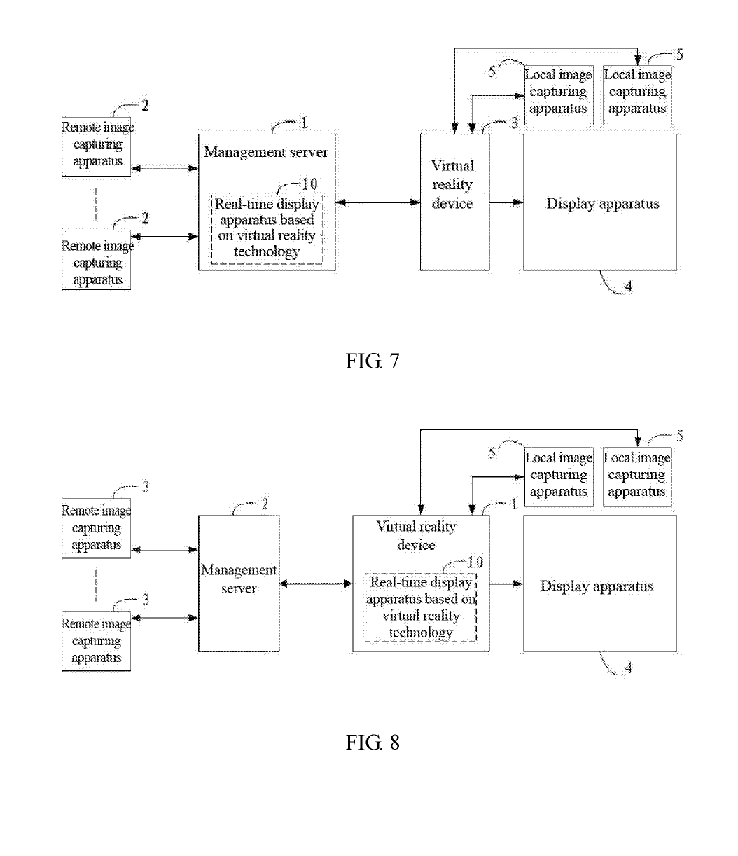

FIG. 7 is a block diagram showing a structure of a displaying system based on a virtual reality technology according to this embodiment. With reference to FIG. 7, the system includes a management server 1, remote image capturing apparatuses 2, a virtual reality device 3, a displaying apparatus 4 and local image capturing apparatuses 5. The management server 1 is provided with the above-mentioned real-time displaying apparatus 10 based on a virtual reality technology.

The remote image capturing apparatuses 2 are arranged at famous scenic spots around the world and are configured to capture real-time video images and send the real-time video images to the management server.

The local image capturing apparatuses 5 are arranged on the displaying apparatus 4 and configured to obtain location information, relative to the displaying apparatus 4, of a face of the user who is in front of the displaying apparatus 4 displaying apparatus and send the location information to the virtual reality device 3.

The virtual reality device 3 is configured to: obtain location information of the face of the user relative to the displaying apparatus 4 and send the location information to the management server 1, receive the video image processed by the management server 1, and send the video image to the displaying apparatus 4 for display.

In this system, the video images captured in real time by the remote image capturing apparatuses are sent to the management server, the virtual reality device obtains the location information of the face of the user relative to the displaying apparatus through the local image capturing apparatuses and sends the location information to the management server, and the management server calculates the viewing angle of the user according to the location information sent by the virtual reality device, crops the video image according to the location information and the viewing angle and sends the cropped video image to the displaying apparatus for display through the virtual reality device, so that a video image of a scenic spot captured in real time is processed according to the location information of the user, just as the user stands in front of a window and enjoys the scenery, thereby meeting a user's demand of enjoying the scenery around the world at home, with good user experience and vivid effect. In this embodiment, the displaying apparatus based on a virtual reality technology is configured on the management server for completing all video image processing tasks on the management server, so that the data transmission volume is reduced, and the network bandwidth requirement is low.

Alternatively, the remote image capturing apparatuses 2 are 360-degree panoramic cameras, which have a large capturing range and meet requirements regardless of the location of the user. The local image capturing apparatuses 5 are wide-angle cameras and have a large capturing range, so that the user has a large movable range.

Alternatively, the management server is a cloud server connected with the virtual reality device over network, and the remote image capturing apparatuses are connected with the management server over network. The management server manages the video images sent from the remote image capturing apparatuses around the world, and the network may be Internet or 3G/4G mobile communication.

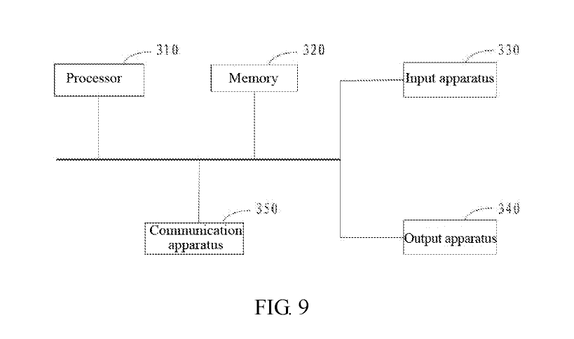

FIG. 8 is a block diagram showing a structure of a displaying system based on a virtual reality technology according to this embodiment. With reference to FIG. 8, the system includes a management server 2, remote image capturing apparatuses 3, a virtual reality device 1, a displaying apparatus 4 and local image capturing apparatuses 5. The virtual reality device 1 is provided with the above-mentioned real-time displaying apparatus 10 based on a virtual reality technology.

The remote image capturing apparatuses 3 are arranged at famous scenic spots around the world and are configured to capture real-time video images and send the real-time video images to the management server 2.

The local image capturing apparatuses 5 are arranged on the displaying apparatus 4 and configured to obtain location information relative to the displaying apparatus 4 of a face of the user who is in front of the displaying apparatus 4 displaying apparatus and send the location information to the virtual reality device 3.

The management server 2 is configured to adjust capturing angles of the remote image capturing apparatuses 3 according to an adjusting instruction sent by the virtual reality device 1; and send the real-time video images captured by the remote image capturing apparatuses to the virtual reality device 1 for processing.

The displaying apparatus 4 is configured to display the video images processed by the virtual reality device 1.

In the system, the video images are captured in real time by the remote image capturing apparatuses and sent to the management server, the management server adjusts the capturing angles of the remote image capturing apparatuses according to the adjusting instruction sent by the virtual reality device land sends the real-time video images captured by the remote image capturing apparatuses to the virtual reality device for processing, so that the video images of the scenic spot acquired in real time are processed according to the location information of the user, just as the user is standing in front of a window and enjoys the scenery, thereby meeting a user's demand of enjoying the scenery around the world at home, with good user experience and vivid effect. In this embodiment, the displaying apparatus based on a virtual reality technology is configured on the virtual reality device, and all video image processing tasks are completed on the virtual reality device, so that the workload of the management server is reduced, the requirement for the server is low, which is beneficial to reduce costs.

Alternatively, the remote image capturing apparatuses are 360-degree panoramic cameras, which have a large capturing range and meet requirements regardless of the location of the user. The local image capturing apparatuses 5 are wide-angle cameras and have a large capturing range, so that the user has a large movable range.

Alternatively, the management server is a cloud server connected with the virtual reality device over network, and the remote image capturing apparatuses are connected with the management server over network. The management server manages the video images sent from the remote image capturing apparatuses around the world, and the network may be Internet or 3G/4G mobile communication.

This embodiment further provides a computer-readable storage medium storing computer executable instructions for executing any one of the above-mentioned displaying methods based on a virtual reality technology.

FIG. 9 is a schematic diagram showing a hardware structure of a management server or virtual reality device according to this embodiment. As shown in FIG. 9, the management server or the virtual reality device may include one or more processors 310 (one processor 310 is exemplarily illustrated in FIG. 9 as an example), and a memory 320.

The management server or the virtual reality device may further include an input apparatus 330 and an output apparatus 340.

The processor 310, the memory 320, the input apparatus 330, and the output apparatus 340 may be connected via a bus or other ways. In FIG. 9, the connection through the bus is taken as an example.

The memory 320, as a computer-readable storage medium, may be used for storing software programs, computer executable programs and modules. The processor 310 executes various functional applications and data processing by running software programs, instructions, and modules stored in the memory 320 so as to implement the displaying method based on a virtual reality technology of any one of the above-mentioned method embodiments. The memory 320 may include a program storage area and a data storage area. The program storage area may store an operating system, and an application program required by at least one function. The data storage area may store data generated in using the management server or the virtual reality device, and the like. The memory 320 may be a non-transitory computer storage medium or a transitory computer storage medium. The non-transitory computer storage media may include volatile memories such as a random access memory (RAM), and may also include non-volatile memories such as at least one magnetic disk storage device, a flash memory device, or other non-volatile solid state memory devices. In some embodiments, the memory 320 optionally includes memories remotely disposed relative to the processor 310, and these remote memories may be connected to the management server or the virtual reality device over a network. Examples of the above network may include Internet, an intranet, a local area network, a mobile communication network, and combinations thereof.

The input apparatus 330 may be configured to receive input numerical or character information and generate a key signal input related to user settings and function control of the management server or virtual reality device. The output apparatus 340 may include a displaying apparatus such as a display screen.

This embodiment may further include a communication apparatus 350 for transmitting and/or receiving information via the communication network.

Finally, it is to be noted that those skilled in the art may understand that all or a part of processes in the methods in the embodiments may be implemented by a computer program executed by related hardware. The computer program may be stored in a non-transitory computer-readable medium, and when executed, may include the procedures of the foregoing method embodiments. The non-transitory computer-readable storage medium may be a magnetic disk, an optical disk, a read only memory (ROM), or a random storage memory (RAM) and the like.

### INDUSTRIAL APPLICABILITY

The present disclosure provides a displaying method, apparatus and system based on a virtual reality technology. The displaying method, apparatus and system realize that video images of a scenic spot, captured in real time are processed according to location information of the user, such that the user may enjoy the scenic spots around the world in real time without leaving his or her home, thereby achieving an effect that the user is just as viewing the scenic spot at the scenic spot.

What is claimed is:

1. A displaying method based on a virtual reality technology, comprising:
obtaining current location information of a user relative to a displaying apparatus, and calculating a current viewing angle of the user according to the current location information, wherein the current viewing angle comprises a horizontal viewing angle and a longitudinal viewing angle;
obtaining a video image of a user-specified spot captured by an image capturing apparatus in real time;
processing the video image according to the current location information and the current viewing angle; and
sending the processed video image to the displaying apparatus for display.

2. The method according to claim 1, wherein the image capturing apparatus is a 360 degrees panoramic camera.

3. The method according to claim 1, wherein the processing the video image according to the current location information and the current viewing angle comprises:
cropping the video image according to the current location information and the current viewing angle if the current viewing angle is less than an angle-of-view of the image capturing apparatus; and
scaling the cropped video image according to a resolution of the displaying apparatus.

4. The method according to claim 1, after the calculating a current viewing angle of the user according to the current location information, the method further comprising: adjusting a capturing angle of the image capturing apparatus if the video image corresponding to the current viewing angle exceeds a range of the video image captured by the image capturing apparatus;
wherein the obtaining a video image of a user-specified spot captured by an image capturing apparatus in real time comprises: obtaining a video image captured by the image capturing apparatus in real time after the capturing angle is adjusted.

5. The method according to claim 4, wherein the adjusting a capturing angle of the image capturing apparatus if the video image corresponding to the current viewing angle exceeds the range of the video image captured by the image capturing apparatus comprises:
calculating a variation between the current viewing angle and a previous viewing angle;
determining whether the video image corresponding to the current viewing angle exceeds the range of the video image captured by the image capturing apparatus according to the variation; and
adjusting the capturing angle of the image capturing apparatus if the video image corresponding to the current viewing angle exceeds the range of the video image captured by the image capturing apparatus.

6. (canceled)

7. (canceled)

8. (canceled)

9. (canceled)

10. (canceled)

11. (canceled)

12. (canceled)

13. (canceled)

14. A displaying apparatus based on a virtual reality technology, comprising:
a virtual reality displaying device,
a processor, and
a memory connected to the processor and for storing instructions executable by the processor,
wherein execution of the instructions by the processor causes the processor to:
obtain current location information of a user relative to the virtual reality displaying device, and calculate a current viewing angle of the user according to the current location information, wherein the current viewing angle comprises a horizontal viewing angle and a longitudinal viewing angle;
obtain a video image of a user-specified spot captured in real time by an image capturing apparatus;
process the video image according to the current location information and the current viewing angle; and
send the processed video image to the virtual reality displaying device for display.

15. The displaying apparatus according to claim 14, wherein the execution of the instructions by the processor further causes the processor to:
adjust a capturing angle of the image capturing apparatus if the video image corresponding to the current viewing angle exceeds a range of the video image captured by the image capturing apparatus, and
receive a video image captured in real time by the image capturing apparatus after the capturing angle is adjusted.

16. The displaying apparatus according to claim 14, wherein the execution of the instructions by the processor further causes the processor to:
crop the video image according to the current viewing angle if the current viewing angle is less than an angle-of-view of the image capturing apparatus; and
scale the cropped video image according to a resolution of the virtual reality displaying device.

17. The displaying apparatus according to claim 14, wherein the image capturing apparatus is a 360 degrees panoramic camera.

18. The displaying apparatus according to claim 15, wherein when adjusting a capturing angle of the image capturing apparatus if the video image corresponding to the current viewing angle exceeds a range of the video image captured by the image capturing apparatus, the execution of the instructions by the processor further causes the processor to:
calculate a variation between the current viewing angle and a previous viewing angle;
determine whether the video image corresponding to the current viewing angle exceeds the range of the video image captured by the image capturing apparatus according to the variation; and
adjust the capturing angle of the image capturing apparatus if the video image corresponding to the current viewing angle exceeds the range of the video image captured by the image capturing apparatus.

19. A non-transitory computer-readable storage medium storing executable instructions that, when executed by a displaying apparatus based on a virtual reality technology, cause the displaying apparatus to:
obtain current location information of a user relative to the virtual reality displaying device, and calculate a current viewing angle of the user according to the current location information, wherein the current viewing angle comprises a horizontal viewing angle and a longitudinal viewing angle;
obtain a video image of a user-specified spot captured in real time by an image capturing apparatus;
process the video image according to the current location information and the current viewing angle; and
send the processed video image to a virtual reality displaying device for display.

20. The non-transitory computer-readable storage medium according to claim 19, wherein the displaying apparatus is further caused to:
adjust a capturing angle of the image capturing apparatus if the video image corresponding to the current viewing angle exceeds a range of the video image captured by the image capturing apparatus, and
receive a video image captured in real time by the image capturing apparatus after the capturing angle is adjusted.

21. The non-transitory computer-readable storage medium according to claim 19, wherein the displaying apparatus is further caused to:
crop the video image according to the current viewing angle if the current viewing angle is less than an angle-of-view of the image capturing apparatus; and
scale the cropped video image according to a resolution of the virtual reality displaying device.

22. The non-transitory computer-readable storage medium according to claim 19, wherein the image capturing apparatus is a 360 degrees panoramic camera.

23. The non-transitory computer-readable storage medium according to claim 20, wherein when adjusting a capturing angle of the image capturing apparatus if the video image corresponding to the current viewing angle exceeds a range of the video image captured by the image capturing apparatus, the displaying apparatus is further caused to:
calculate a variation between the current viewing angle and a previous viewing angle;
determine whether the video image corresponding to the current viewing angle exceeds the range of the video image captured by the image capturing apparatus according to the variation; and
adjust the capturing angle of the image capturing apparatus if the video image corresponding to the current viewing angle exceeds the range of the video image captured by the image capturing apparatus.
